(19) United States
(12) Patent Application Publication
(10) Pub. No.: US 2014/0045127 A1
(43) Pub. Date: Feb. 13, 2014

(54) Herbal Infused Candles

(71) Applicant: Christopher Jacobs, Sumter, SC (US)

(72) Inventor: Christopher Jacobs, Sumter, SC (US)

(21) Appl. No.: 13/691,768

(22) Filed: Dec. 1, 2012

Related U.S. Application Data
(60) Provisional application No. 61/682,274, filed on Aug. 12, 2012.

(51) Int. Cl. C11C 5/00; C11C 5/02

(52) U.S. Cl. CPC C11C 5/002; C11C 5/023
USPC 431/291; 264/112

(57) ABSTRACT

The invention is herbal infused candles and the method for producing the same. The candles are made from paraffin or other wax and a selection of natural herbs and plant materials. The candles are produced by coating a glass jar with a spray adhesive and then adding a mixture of herbs or other plant materials to the jar in a sufficient quantity to coat the interior of the glass jar. The jars are then chilled. Wax is melted and then poured into the chilled jars. A wick is inserted into each filled jar

### CROSS REFERENCE TO RELATED APPLICATIONS

Provisional Patent Application No.: 61/682,274

Filing Date: Aug. 12, 2012

Relationship: Provisional application for the same invention

### STATEMENT REGARDING FEDERALLY SPONSORED RESEARCH OR DEVELOPMENT

This invention was not made by an agency of the United States Government nor under a contract with an agency of the United States Government.

### PARTIES TO JOINT RESEARCH AGREEMENT

Not Applicable.

### REFERENCE TO SEQUENCE LISTING

Not Applicable.

### BACKGROUND OF THE INVENTION

The earliest use of candles date back over 5,000 years to the ancient Romans and Egyptians who produced them by repeatedly dipping rolled papyrus in melted tallow (rendered animal fat) or beeswax. Candles were used to provide light and in religious ceremonies. Candles were also used as early methods of timekeeping.

Early western cultures used primarily tallow and beeswax candles. Beeswax candles were considered to be superior to tallow candles as the beeswax candles burned cleanly without the smoky flame of tallow candles. Beeswax candles also produced a more pleasant scent than the foul, acrid odor of burning tallow. However, as beeswax candles were more expensive, they were generally used only by the wealthy and the church.

Paraffin wax was introduced to candle making during the 19th century. Like beeswax candles, paraffin candles burned without the smoky flame associated with tallow candles. Paraffin candles were also odorless when burned. Introduction of paraffin was considered as a boon to the candle industry as it resulted in a superior and less expensive candle. The boon was short-lived as the candle industry began to decline with the introduction of the electric light bulb in the late 19th century.

Although candles are no longer used as a major source of light, candles continue to be popular. Candles are used to mark celebrations, in religious ceremonies, as a mood setter, as home decor accent and as a component in aromatherapy.

Aromatherapy is a form of alternative medicine that uses volatile plant materials, known as essential oils, and other aromatic compounds for the purpose of altering a person's mind, mood, cognitive function or health. Efficacy of therapeutic benefits of aromatherapy is scientifically unproven. However, at a minimum, it can be a pleasurable experience for the recipient. Methods of aromatherapy include (1) aerial diffusion for environmental fragrance; (2) direct inhalation; and (3) topical applications.

### BRIEF SUMMARY OF THE INVENTION

The invention described in this application is herbal infused candles and the method for producing the same. The candles are made from paraffin or other wax and a selection of natural herbs and plant materials. The utilization of this invention provides aerial diffusion for environmental fragrance.

The candles are produced by coating a glass jar with a spray adhesive and then adding a mixture of herbs or other plant materials to the jar in a sufficient quantity to coat the interior of the glass jar. The jars are then chilled. Wax is melted and combined with various dyes and then poured into the chilled jars. A wick is inserted into each filled jar.

### BRIEF DESCRIPTION OF THE SEVERAL VIEWS OF THE DRAWING

FIG. 1 provides a flow chart showing the process steps utilized in producing the herbal infused candles.

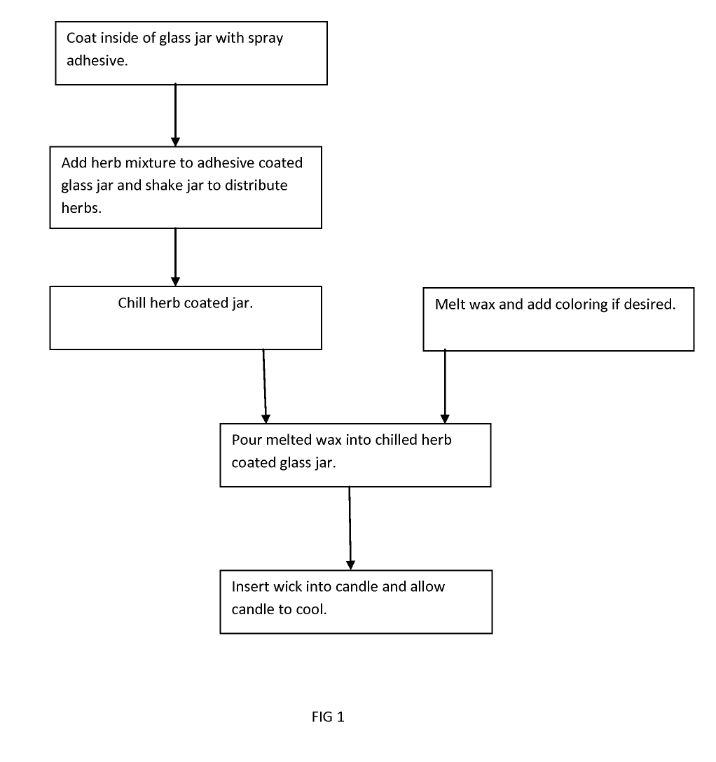

### DETAILED DESCRIPTION OF THE INVENTION

The invention described in this application is an herbal infused candle and the method for producing the same. The candles are made from paraffin or other wax and a selection of natural herbs and plant materials. The herbs and plant materials include but are not limited to Balm of Gilead, Bittersweet, Cinnamon, Chamomile, Patchouli, Rose Buds, Rose Petals, Alfalfa, Dill, Honeysuckle, Strawberry leaves, Amula, Cat's Claw, Dittany of Crete, Heather flowers, Mugwort, Malva, Adder's Tongue, Eucalyptus, Lavender, Rosemary and Thyme.

The candle is produced by coating the inside of a glass jar with a commercially available spray adhesive. A mixture of natural herbs and/or plant materials is then added to the jar and the jar shaken to distribute the herbs/plant material on the inside surface of the glass jar. The herbal coated glass jar is then chilled in a freezer.

Paraffin or other wax material is melted and coloring, if desired, is added to the molten wax. The melted paraffin wax is then poured into chilled herbal coated glass jar. The paraffin wax hardens very quickly infusing the herbs into the wax and sealing the herbs to the sides of the glass jar. A wick is inserted into the center of the cooling wax.

The invention described in this application differs significantly from U.S. Pat. No. 8,196,343—Candlestick with annular live floral holder, issued Jun. 12, 2012 to Michael J. McGuire. The McGuire patent covers a holder for a live floral arrangement with the holder surrounding a taper or column candlestick. Several earlier patents also describe floral arrangement and candle holders. These include U.S. Pat. No. 3,303,610 issued Feb. 14, 1967 to Paul F. K. Erbguth; 2,876,587 issued Oct. 1, 1954 to David Saks; 2,686,989 issued Jul. 13, 1949 to Annie Lee Dillon; and 1,631,631 issued Feb. 16, 1926 to Gertrude Gerlinger. Like the McGuire patent, these patents describe inventions in which the floral arrangement is separate from the candle. In the invention described in this application, the plant matter is infused in the wax and is part of the candle.

A potential patent classification for this invention is Class 44: Fuel and Related Compositions; Sub-Class 275: Candle Composition. A second potential patent classification for this invention is Class 431: Combustion; Sub-Class 291: Apparatus including a surrounding casing or wall extending the full length of the solid fuel body.

The invention claimed is:

1. A method for producing herbal infused candles consisting essentially of coating the interior surface of a glass jar with a spray adhesive; adding a mixture of herbs/plant matter to the coated jar and shaking the jar to distribute the herbs/plant matter on the interior surface of the glass jar; chilling the herbal coated glass jar; pouring molten paraffin or other molten wax into the chilled herbal coated glass jar and adding a wick.

2. The method according to claim 1, wherein said mixture of herbs/plant matter comprises Balm of Gilead, Bittersweet, Cinnamon, Chamomile, Patchouli, Rose Buds, Rose Petals, Alfalfa, Dill, Honeysuckle, Strawberry leaves, Amula, Cat's Claw, Dittany of Crete, Heather flowers, Mugwort, Malva, Adder's Tongue, Eucalyptus, Lavender, Rosemary and Thyme.

3. A candle infused with a mixture of herbs/plant matter in a glass jar.

4. The candle according to claim 3, wherein said mixture of herbs/plant matter comprises Balm of Gilead, Bittersweet, Cinnamon, Chamomile, Patchouli, Rose Buds, Rose Petals, Alfalfa, Dill, Honeysuckle, Strawberry leaves, Amula, Cat's Claw, Dittany of Crete, Heather flowers, Mugwort, Malva, Adder's Tongue, Eucalyptus, Lavender, Rosemary and Thyme.
